(19) United States
(12) Patent Application Publication
(10) Pub. No.: US 2019/0200109 A1
(43) Pub. Date: Jun. 27, 2019

(54) Speaker Box

(71) Applicant: AAC Technologies Pte. Ltd., Singapore city (SG)

(72) Inventors: YuGuo Zhang, Shenzhen (CN); Zhang Ren, Shenzhen (CN)

(21) Appl. No.: 16/057,930

(22) Filed: Aug. 8, 2018

(30) Foreign Application Priority Data
Dec. 21, 2017 (CN) 201711393985.9

(51) Int. Cl. H04R 1/02; H04R 7/12

(52) U.S. Cl. CPC H04R 1/025; H04R 7/127; H04R 31/003; H04R 2400/11; H04R 2499/11

(57) ABSTRACT

The present invention provides a speaker box having an elastic gasket arranged along a circumference of a diaphragm and located between a speaker and a supporting wall where the speaker locates, which provides more effective buffering function, and improves the stability of the speaker box.

### FIELD OF THE PRESENT DISCLOSURE

This disclosure related to the field of electro-acoustic transducers, and more particularly to a speaker box used in a portable electronic device, like a mobile phone.

### DESCRIPTION OF RELATED ART

A mobile phone is more and more popular in day life. As one important feature of a mobile phone, music play-back is one of the concerns for a user to choose a phone. A speaker box is a component, or a transducer to convert electrical signals to audible sounds (music).

A related speaker box includes an upper cover, a lower cover forming an accommodation space together with the upper cover, a speaker accommodated in the accommodation space, and a sound passageway communicating with the accommodation space. The upper cover forms a supporting wall for fixing the speaker, and a front sound cavity is formed between the speaker and the upper cover. The sound passageway forms a front cavity cooperatively with the front sound cavity. Generally, the speaker is fixed to the supporting wall only by adhesive. In addition, the speaker box generally provides a sealing foam positioned in the sound passageway.

In the related speaker box, the upper cover is partially made of rigid plastic or metal plate, which produces high frequency distortion of the front sound cavity. At the meantime, the supporting wall is made of rigid plastic so that the buffing ability of the supporting wall is poor and further the stability thereof is not sufficient during dropping.

Therefore it is necessary to provide an improved speaker box for overcoming the above-mentioned disadvantages.

### BRIEF DESCRIPTION OF THE DRAWINGS

Many aspects of the exemplary embodiment can be better understood with reference to the following drawing. The components in the drawing are not necessarily drawn to scale, the emphasis instead being placed upon clearly illustrating the principles of the present disclosure.

FIG. 1 is an isometric view of a speaker box in accordance with an exemplary embodiment of the present invention.

FIG. 2 is an isometric and exploded view of the speaker box in FIG. 1.

FIG. 3 is a cross-sectional view of the speaker box in FIG. 1.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

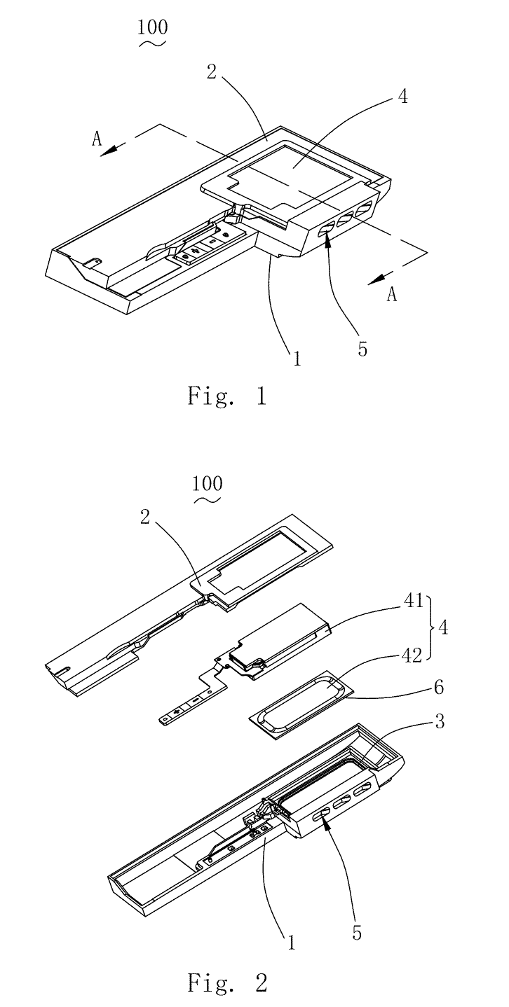

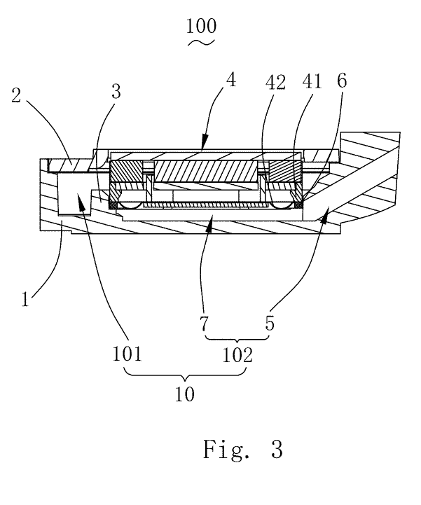

Referring to FIGS. 1-3, an exemplary embodiment of the present invention discloses a speaker box 100 including an upper cover 1, a lower cover 2, an accommodation space 10 formed cooperatively by the upper cover 1 and the lower cover 2, a speaker 4 accommodated in the accommodation space 10, a sound passageway 5, and an elastic gasket 6. The upper cover 1 can be formed integrally with the lower cover 2, or connected with the lower cover 2. The top cover 1 forms a supporting wall 3 extending therefrom toward the lower cover 2 for fixing the speaker 4 in the accommodation space 10. Thus, the speaker 3 divides the accommodation space 10 into a front sound cavity 7 and a rear cavity 101. Another word, the speaker 4 and the upper cover 1 cooperatively form the front sound cavity 7, and the speaker 4 forms the rear cavity 101 together with the upper cover 1 and the lower cover 2.

The speaker 3 includes a frame 41 and a diaphragm 42 positioned by the frame 41. The frame 41 is fixed to the supporting wall 3 with a portion of the frame 41 adjacent to the diaphragm 42 assembled with the supporting wall.

The sound passageway 5 is formed in accommodation space 10. Specifically, the sound passageway 5 is formed in the upper cover 1. The sound passageway 5 and the front sound cavity 7 cooperatively form a front cavity 102.

The elastic gasket 6 is arranged on a side of the diaphragm 42 adjacent to the supporting wall 3, and is made of flexible material (like rubber). Optionally, the elastic gasket 6 is arranged on the diaphragm 42 along a circumference of the diaphragm 42. The elastic gasket 6 can be integrally formed with the diaphragm 42 by extrusion molding or insert molding, or hot pressing. In the embodiment, the elastic gasket 6 serves as a buffering member. According to actual requirements, the elastic gasket 6 may be configured as a complete ring attached to the diaphragm, or be configured as a plurality of sections arranged on the diaphragm. In the embodiment, the elastic gasket 6 is located between the supporting wall 3 and the diaphragm 42.

Preferably, the elastic gasket 6 is made of flexible material with Young's modulus value smaller than the Young's modulus value of the upper cover 1. Optionally, the material may be selected from TPE, TPU and silica. By virtue of the elastic gasket 6, vibration or bump produced by the speaker 4 can be adsorbed, and the stability of the speaker box 100 is accordingly improved.

The present invention provides a speaker box having an elastic gasket arranged along a circumference of the diaphragm and located between the speaker and the supporting wall where the speaker locates, which provides more effective buffering function, and improves the stability of the speaker box.

It is to be understood, however, that even though numerous characteristics and advantages of the present exemplary embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A speaker box, including:
a lower cover;
an upper cover forming an accommodation space cooperatively with the lower cover, the upper cover including a supporting wall extending therefrom toward the lower cover;
a speaker received in the accommodation space and positioned on the supporting wall, the speaker including a frame and a diaphragm fixed by the frame;
a sound passageway communicating with the accommodation space;
a front sound cavity formed by the speaker and the upper cover;
a front cavity formed by communicating the front sound cavity and the sound passageway; and
an elastic gasket arranged along a circumference of the diaphragm and located between the diaphragm and the supporting wall.

2. The speaker box as described in claim 1, wherein the elastic gasket is integrally formed with the diaphragm.

3. The speaker box as described in claim 2, wherein the elastic gasket is a ring located on the circumference of the diaphragm.

4. The speaker box as described in claim 2, wherein the elastic gasket includes a plurality of sections arranged along the circumference of the diaphragm.

5. A speaker box, including:
a housing formed by assembling a first cover and a second cover;
a supporting wall located in the housing and formed by extending along a direction from the first cover toward the second cover;
a speaker supported by the supporting wall in the housing;
a buffering member made of flexible material located between the speaker and the supporting wall for adsorbing vibration of the speaker.

6. The speaker box as described in claim 5, wherein the buffering member is an elastic gasket arranged along a circumference of the speaker.

7. The speaker box as described in claim 6, wherein the speaker includes a frame and a diaphragm fixed by the frame for producing audible sound, and the elastic gasket is arranged along a circumference of the diaphragm for being sandwiched between the diaphragm and the supporting wall.

8. A speaker box, including:
a housing forming an accommodation space;
a supporting wall extending in the accommodation space;
a speaker engaged with the supporting wall for being positioned in the accommodation space, the speaker having a sound radiation surface and a frame for positioning the sound radiation surface;
a buffering member sandwiched between the supporting wall and the sound radiation surface for adsorbing the bumping produced between the supporting wall and the speaker.
